(19) United States
(12) Patent Application Publication
(10) Pub. No.: US 2026/0037982 A1
(43) Pub. Date: Feb. 5, 2026

(54) SYSTEM AND METHOD FOR AGGREGATING CONTRIBUTOR FUNDS INTO A UNIFIED PAYMENT INSTRUMENT

(71) Applicants: Mark Hann, Dallas, TX (US); Eian Aldrich, Davenport, IA (US)

(72) Inventors: Mark Hann, Dallas, TX (US); Eian Aldrich, Davenport, IA (US)

(21) Appl. No.: 19/286,642

(22) Filed: Jul. 31, 2025

Related U.S. Application Data
(60) Provisional application No. 63/678,378, filed on Aug. 1, 2024.

(51) Int. Cl. G06Q 20/40; G06Q 20/34

(52) U.S. Cl. CPC G06Q 20/405; G06Q 20/407; G06Q 20/351

(57) ABSTRACT

A system and method are provided for dynamically aggregating financial pledges from one or more contributors onto a single payment instrument compatible with standard payment networks. An organizer may create a purchasing fund and invite participants via a dynamic link. Participants may pledge contribution amounts and link payment methods, which are verified and pre-authorized upon fund activation. The system generates a virtual or physical payment instrument backed by the aggregated amount and enables transactions that are automatically allocated across contributors according to their pledges. The system supports real-time updates, post-activation participant additions, refund redistribution, and payment instrument regeneration. Refunds issued by merchants are proportionally allocated back to contributors. The system includes modules for fund management, transaction orchestration, notification delivery, fraud monitoring, and wallet integration, and may operate via cloud-based microservices interacting with secure datastores and external payment gateways.

### CROSS-REFERENCE TO RELATED APPLICATIONS

The present application claims priority to U.S. Provisional Application No. 63/678,378 filed Aug. 1, 2024, titled “SYSTEM AND METHOD FOR CONSOLIDATING FUNDS ONTO A VIRTUAL CARD,” which is hereby incorporated by reference in its entirety.

### TECHNICAL FIELD

The embodiments generally relate to the technical field of electronic payment processing systems.

### BACKGROUND

Conventional payment systems typically process transactions using a single funding source linked to a user's credit card, debit card, or digital wallet. These systems are designed for individual purchases and provide limited flexibility for collaborative or multi-party funding scenarios. In traditional group payment contexts, individuals often rely on reimbursement-based methods, where one participant makes a purchase and others settle their portion afterward through peer-to-peer payment apps or manual transfers. While this approach enables shared costs, it introduces administrative complexity, delays in repayment, and potential misunderstandings regarding individual contributions.

Some financial platforms allow users to create pooled or shared accounts, but these often require all participants to establish a formal relationship with the platform or financial institution, limiting their accessibility and scalability. Moreover, such systems may lack real-time transparency and control, especially in dynamic situations where participant roles or contributions evolve during the transaction process. Conventional refund mechanisms further complicate group purchases, typically routing reimbursements to the original payer, which can impose additional steps for equitable redistribution.

Payment instruments in these systems, whether physical cards, virtual tokens, or mobile wallet credentials, are generally tied to a single funding account. They do not natively support real-time adjustments to backing sources, nor do they incorporate logic for allocating payments across multiple contributors at the moment of transaction. As a result, users seeking to share purchasing responsibilities must often coordinate outside the payment system itself, increasing friction in both online and in-person transaction environments.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

Embodiments described herein relate to a software-based system for aggregating pledged funds from one or more contributors onto a single payment instrument that is compatible with standard payment networks. The system enables an organizer to create a purchasing fund, invite participants via dynamic links, and accept pledge commitments from each participant through designated payment methods. Unlike conventional payment systems that rely on a single funding source or require manual reimbursement after a purchase, the disclosed system consolidates these pledges into a unified spendable limit and activates a virtual or physical payment instrument when the fund reaches a desired threshold or is manually triggered.

The platform supports both open and contribution-based funding models, allowing participants to pledge flexible or predefined amounts. It provides real-time visibility into group funding progress and facilitates seamless participant onboarding before or after activation. Upon activation, the system places pre-authorization holds or finalized charges on each payment method, ensuring that the aggregated payment instrument is sufficiently backed. The instrument is then usable across online and in-store environments without requiring special merchant integration.

During transaction settlement, the system automatically allocates the purchase amount proportionally among participants based on their pledged contributions, ensuring each contributor is charged only up to their defined limit. It also handles partial and full refunds by redistributing funds according to the original contributions or a custom allocation defined by the organizer. The system further supports real-time notifications, fraud detection, and replenishment logic triggered by fund utilization thresholds or declined transactions. These features reduce friction in group purchases, eliminate the need for manual reimbursements, and offer dynamic control throughout the purchasing lifecycle.

The system may be implemented as a set of interoperable software modules operating on a server platform. A fund management module may handle the creation, configuration, and lifecycle of purchasing funds, including tracking the funding goal, contribution model (open or predefined), and activation status. A participant interface module may allow users to join a fund, submit or revise pledges, and view real-time dashboards showing contribution status, transaction history, and refund details. A payment orchestration module may coordinate the placement of pre-authorization holds or finalized charges on participant-linked payment methods upon fund activation and may generate or designate a payment instrument backed by the aggregated pledge amount. A transaction settlement module may allocate purchase costs among participants, enforcing each individual's pledged limit and dynamically adjusting allocations during settlement events. A manual adjustment module may allow the organizer to manually adjust each participant's funding amounts within their pre-authorized limits A refund allocation module may distribute partial or full refunds proportionally or according to organizer-defined rules. A notification module may deliver real-time alerts about fund activity, including participant joins, transactions, and fund closure events. A replenishment module may respond to declined transactions or high utilization thresholds by prompting for additional contributions and updating the fund balance accordingly. A security and fraud monitoring module may detect anomalous behavior or inconsistencies in participant activity, and a wallet integration module may enable both virtual and physical payment instruments to operate across mobile platforms and standard payment networks.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3A illustrates an example method for activating a purchasing fund, transacting with an aggregated payment instrument, and handling post-purchase operations, according to some embodiments;

FIG. 3B illustrates an example method for activating a purchasing fund, transacting with an aggregated payment instrument, and handling post-purchase operations, according to some embodiments;

FIG. 4 illustrates an example system architecture for handling real-time fund updates and client synchronization using the Aggregated Payment System (APS) service, according to some embodiments;

FIG. 5 illustrates an example process for activating a purchasing fund and generating a tokenized payment instrument, according to some embodiments;

FIG. 6 illustrates an example refund handling workflow for allocating and processing refunds issued to an aggregated payment instrument, according to some embodiments; and

FIG. 7 illustrates an example system deployment architecture for the Aggregated Payment System (APS), showing how participant devices interact with distributed services and data layers to manage purchasing funds, transaction execution, and payment instrument provisioning, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A software-based system may be used to consolidate financial pledges from one or more contributors into a single payment instrument accepted across standard payment networks. The system may include one or more server nodes, memory devices storing executable instructions, and one or more processors configured to perform operations for managing purchasing funds, receiving pledges, generating payment instruments, settling transactions, and distributing refunds.

A processor may receive a request from an organizer device to establish a purchasing fund. The request may include a goal amount, a group identifier, and a specification of funding model parameters, such as whether the fund allows open pledging or requires defined contribution levels. Upon receiving the request, the system may initiate the fund in a pending state and generate a dynamic invitation link. This link may be sent to multiple participant devices and may contain metadata reflecting the current pledge level, funding goal, and status of participation.

Participant devices may interface with the system through web or native applications that display fund details and allow users to pledge an amount using an associated payment method. The processor may store each pledge in a database record, associating it with the participant's account, the selected payment method, and the relevant purchasing fund. Prior to activation, participants may modify or withdraw their pledges, subject to any constraints defined by the organizer. The system may continuously update the total available pledge balance and dynamically adjust the group status visible in the invitation link.

Once the purchasing fund reaches a threshold or upon explicit instruction by the organizer, the organizer may activate the fund for a lower amount, without all participants in the group. During this process, the system may place pre-authorization holds or finalized charges against the underlying payment methods of each participant, in accordance with their respective pledged amounts. The processor may then generate or designate a payment instrument backed by the aggregated total of all committed pledges. This payment instrument may take the form of a virtual card, a physical card, or a static account token compatible with global card networks. The payment instrument may be configured with a transaction limit matching the authorized fund balance and may be registered with a payment processor gateway.

When a user presents the payment instrument to a merchant, whether online or in-store, the system may receive a transaction authorization request. The processor may determine if the requested amount is within the available aggregated limit. If approved, the processor may allocate the transaction amount proportionally across participants, calculating each individual's share based on their pledged percentage or a fixed value. These charges may be routed through tokenized payment credentials to the respective financial institutions or card networks.

Upon completion of a transaction, the processor may trigger real-time notifications to all participants. These messages may include the transaction amount, merchant identity, each participant's contribution amount, and remaining balance information. Notifications may be sent through email, SMS, push notifications, or in-app alerts, depending on user preferences.

If a refund is issued by the merchant to the payment instrument, the processor may calculate the proportional refund distribution across all contributors. The refunded amounts may be credited directly to the payment methods originally used by each participant. In some cases, the organizer may define custom allocation rules, such as fixed refund ratios or tiered percentages, which the processor may enforce through a rules engine.

The system may support persistent virtual cards associated with a user's account, enabling continuity across multiple purchasing funds. These cards may be regenerable by the user or administrator upon request, such as in cases of suspected fraud or credential expiration. Regeneration may be facilitated by a secure interaction between the APS and the issuing processor, without requiring reauthorization of previously pledged funds.

In some embodiments, additional participants may be added to a purchasing fund after activation, subject to organizer-defined permissions. Upon receiving a new pledge from a post-activation participant, the system may initiate a pre-authorization hold or finalized capture on the associated payment method for the pledged amount. The available balance of the active aggregated payment instrument may be updated accordingly. The processor may revise the participant ledger stored in the system database to reflect the new contributor's proportional share of the total fund. In configurations where contribution redistribution is permitted, the system may also adjust previously established participant shares downward to reflect a reduced required contribution per person, thereby recalculating transaction allocations based on the updated pool of active participants and their pledged amounts. The system may include logic to detect when the fund's cumulative spend approaches a defined utilization threshold. Upon reaching this threshold, or when a purchase authorization is declined due to insufficient balance, the processor may send a prompt to one or more designated participants, requesting additional contributions. If new pledges are received and verified, the processor may increase the payment instrument's live balance without revoking or regenerating the card.

The processor may support transferring fund ownership to another user. Transfer operations may include updating the fund's metadata to designate a new organizer and optionally migrating access credentials. To close a fund, the organizer or an external event may signal a termination instruction. The processor may calculate any unused balance, reverse holds, and process proportional refunds to the corresponding payment methods. The system may then mark the fund and its associated payment instrument as closed, invalidating any future transactions.

Each participant may access a dashboard interface through which they may view their pledge amount, transaction history, refund activity, and current fund status. The processor may generate this data in real time based on backend ledger entries and transaction logs. Additionally, the system may include monitoring logic that uses predefined rules or artificial intelligence to detect anomalous behavior, such as irregular funding patterns or abnormal merchant activity. The system may flag such events and escalate them to administrative personnel or halt related transactions.

The system may support storing the virtual payment instrument in a digital wallet, such as Apple Pay or Google Pay, enabling near-field communication (NFC)-based transactions at point-of-sale terminals. For physical card embodiments, the system may coordinate shipment of a personalized card to the user, with activation controlled via a secure interface. The physical card may mirror the parameters of the underlying purchasing fund and may include expiration and regeneration protocols managed through the platform.

Various implementations of the invention involve the technical field of electronic payment processing systems including receiving, from an organizer, a request to initiate a purchasing fund with at least one funding model selected from open or contribution-based; presenting a dynamic invitation link to prospective participants, the link displaying real-time funding progress; receiving pledges from a plurality of participants, each pledge associated with a respective payment method; upon reaching a funding threshold or receiving an activation input, placing pre-authorization holds or charges on the pledged amounts; generating or activating a payment instrument linked to the purchasing fund, the instrument being accepted by standard payment networks; processing transactions made using the payment instrument, including calculating and charging each participant's share of the purchase; and automatically redistributing any refunds proportionally based on participant contributions or a predefined allocation rule and are therefore necessarily rooted in computer technology. For example, the aforementioned steps are inherently computer-based and cannot be performed in the human mind.

The present invention also amounts to more than merely implementing the generic computer as a tool to gather, analyze, and output data because the steps of the present method, system, or product improve the electronic payment processing systems by providing a unified solution for funding and executing purchases using a single payment instrument backed by multiple contributors, addressing limitations in conventional systems that rely on single-source payment methods or manual post-purchase reimbursements. Unlike traditional tools that lack real-time transparency and dynamic contribution handling, this system enables participants to pledge funds, modify commitments, and collectively back a virtual or physical card accepted on standard payment networks. It automatically allocates charges and refunds proportionally, supports post-activation participation, and eliminates the need for informal repayment or separate coordination outside the payment flow.

Additionally, the steps of the present invention would be impossible to accomplish on pen and paper due to the volume of data being communicated and received over a network in real-time. In particular, the speed at which the steps of the present invention occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present invention include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present invention would be impossible to accomplish on pen and paper or in the human mind due to the volume of data being analyzed and transformed by the artificial intelligence model.

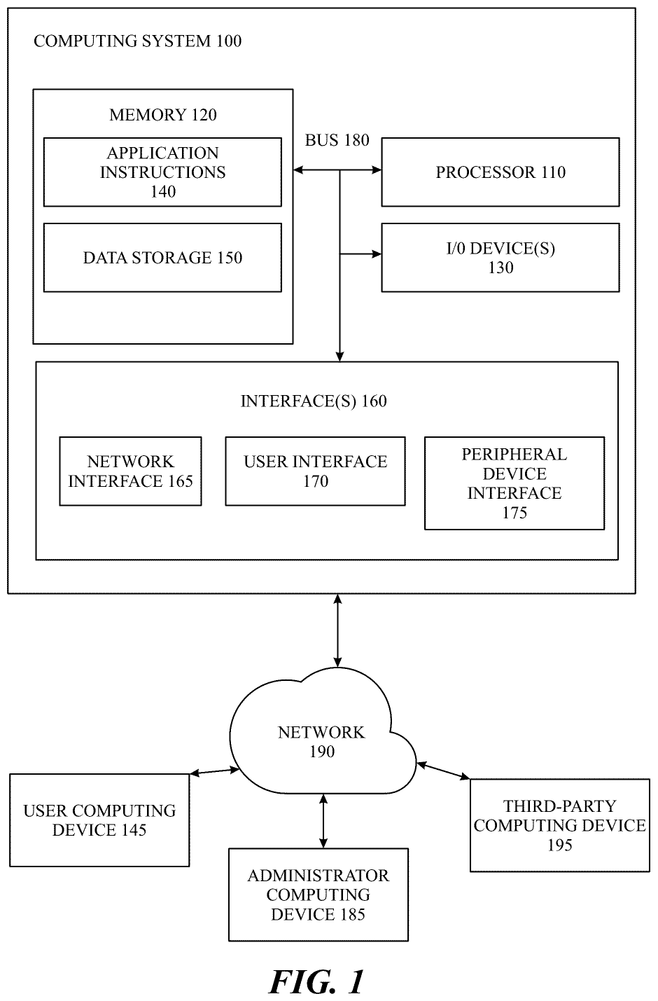

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

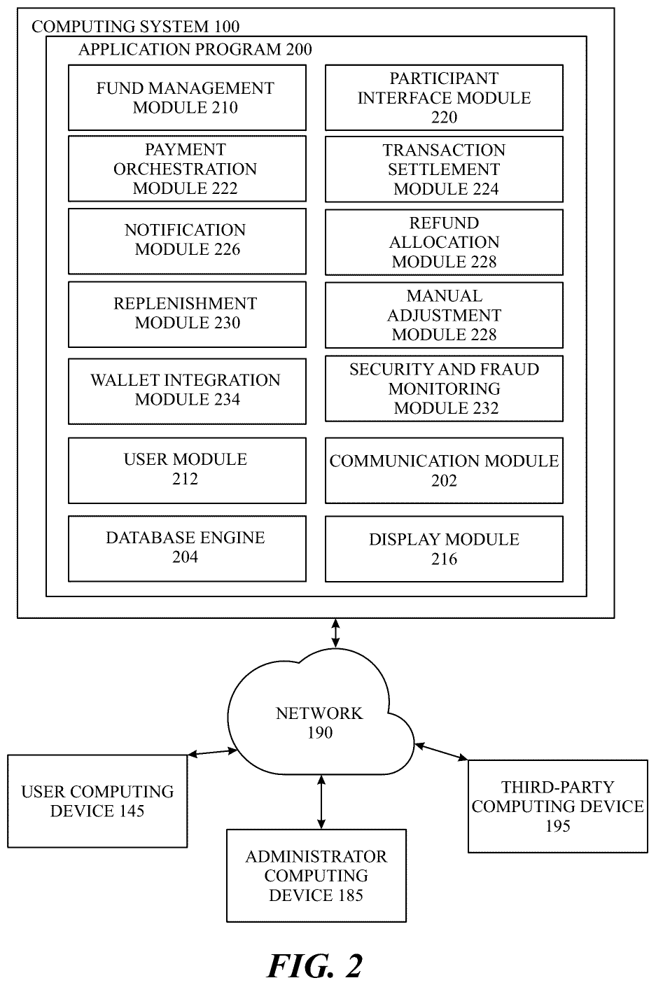

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a fund management module 210, a participant interface module 220, a payment orchestration module 222, a transaction settlement module 224, a notification module 226, a refund allocation module 227, manual adjustment module 228, a replenishment module 230, a security and fraud monitoring module 232, a wallet integration module 234, a communication module 202, a database engine 204, a user module 212, and a display module 216.

In some embodiments, the fund management module 210 is configured to create and manage purchasing funds associated with group payments. The fund management module 210 may receive input from an organizer computing device to establish parameters such as a funding goal, contribution model (open or predefined), and activation conditions. It may store and update fund metadata in coordination with database engine 204 and track the state of the fund, pending, active, or closed, based on system events and organizer actions.

In some embodiments, the participant interface module 220 is configured to provide interactive screens or interfaces through which users may view fund details, pledge an amount, modify existing pledges, or withdraw participation. The module 220 may interact with the communication module 202 and display module 216 to generate dynamic views of current contribution status, open participation slots, or real-time pledge summaries based on data retrieved from the database engine 204.

In some embodiments, the payment orchestration module 222 is configured to manage financial authorization events associated with pledges. Upon activation of a fund, the module 222 may initiate pre-authorization holds or direct charges against participant-linked payment methods through one or more third-party computing devices 195, such as payment gateways or tokenization services. It may use tokenized credentials stored securely via PCI DSS-compliant storage systems and may allocate the fund balance to a designated payment instrument.

In some embodiments, the transaction settlement module 224 is configured to calculate and apply each participant's share of an authorized transaction. It may receive merchant transaction data routed through the network 190 and apply allocation rules, such as proportional distribution or organizer-defined logic, based on each participant's pledged share. The transaction settlement module 224 may also adjust allocation values if a merchant subsequently modifies the transaction amount (e.g., adding gratuity).

In some embodiments, the refund allocation module 227 and the manual adjustment module 228 are configured to manage redistribution of refunds from merchants to participants. When a merchant processes a refund to the aggregated payment instrument, the refund allocation module 227 and the manual adjustment module 228 may determine the appropriate allocation of refunded amounts and execute transactions that return each share to the corresponding payment method. The allocation logic may be proportional to prior charges or defined by custom rules set by the organizer.

In some embodiments, the notification module 226 is configured to generate and deliver real-time messages to participants and organizers regarding fund activity. Notifications may include fund activation, transaction authorizations, contribution changes, refunds, or fund closure events. The notification module 226 may transmit messages through communication channels including email, SMS, push notifications, or in-app alerts by interacting with communication module 202.

In some embodiments, the replenishment module 230 is configured to monitor the balance of an active purchasing fund and prompt participants to contribute additional funds when needed. It may detect low-balance conditions, such as reaching a predefined utilization threshold or receiving a transaction decline due to insufficient funds. In response, the module 230 may transmit prompts and process incoming pledges to update the aggregated balance in real time.

In some embodiments, the wallet integration module 234 is configured to enable virtual payment instruments to operate within third-party digital wallets. It may package and transmit the aggregated payment instrument's credentials in a format compatible with mobile wallets such as those supporting near-field communication (NFC) standards. The module 234 may also facilitate loading, management, and deletion of wallet-based credentials through secure user interfaces.

In some embodiments, the security and fraud monitoring module 232 is configured to monitor system activity for patterns consistent with misuse, suspicious behavior, or fraud. It may analyze pledge behaviors, transaction frequency, merchant data, and participant relationships using predefined rule sets or adaptive anomaly detection algorithms. Upon detecting a risk, it may flag transactions for review or temporarily suspend activity for affected accounts.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others. In some embodiments, when a participant adds a payment method, the user module 212 may transmit the underlying credentials to a third-party payment processor or tokenization service, which returns a unique, non-sensitive token representing that payment source. This token may then be stored in a secure token vault maintained by the APS, without retaining raw cardholder data on APS infrastructure. Each stored token may be associated with a user profile managed by the user module 212 and linked to one or more purchasing funds. During fund activation or transaction processing, the system may reference these tokens to authorize or capture charges without directly handling or exposing sensitive financial information. All tokenized payment methods may be encrypted at rest, access-controlled, and compliant with applicable data security standards such as PCI DSS.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

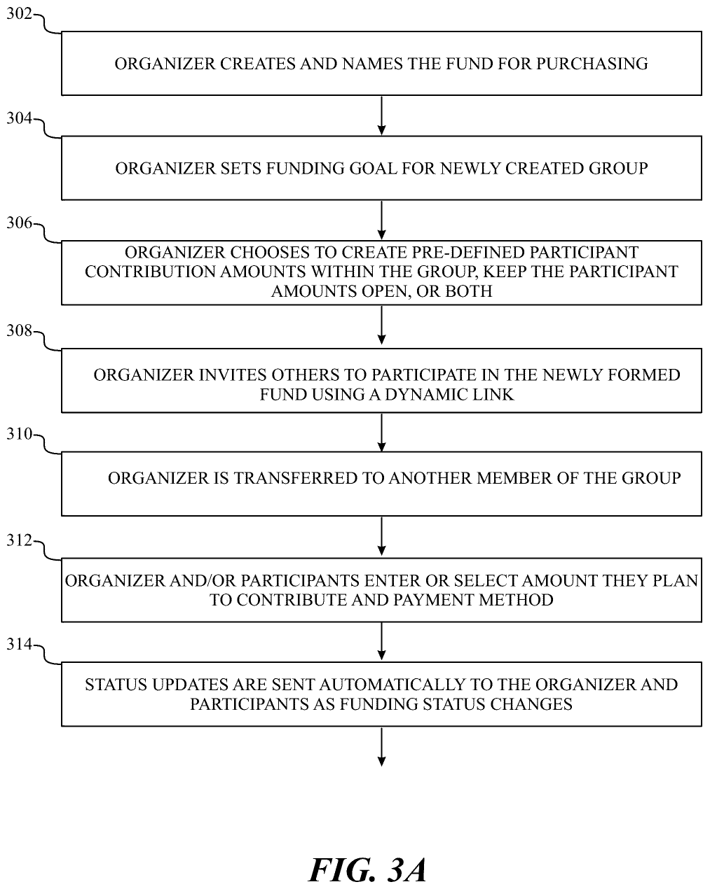

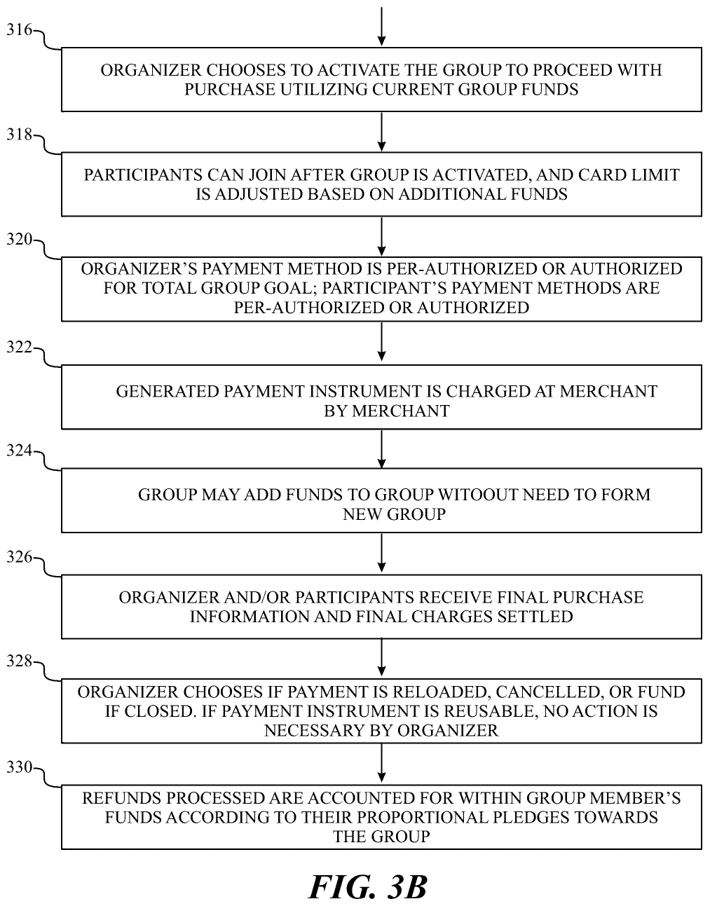

FIG. 3A illustrates an example method for initializing and managing a purchasing fund using the computing system 100. The process may be performed by one or more components of application program 200, including the fund management module 210, participant interface module 220, communication module 202, and user module 212.

At block 302, the organizer creates and names a purchasing fund. This action may be performed through a user computing device 145 interfacing with the fund management module 210, which stores the fund metadata and assigns an identifier for future reference.

At block 304, the organizer sets a funding goal for the newly created fund. The funding goal may represent a target amount to be aggregated through contributions from one or more participants and may be stored by the database engine 204 in association with the fund.

At block 306, the organizer selects a contribution model for the fund. The organizer may configure the fund to use predefined participant contribution amounts, allow open contribution values, or a hybrid of both. These configurations may be stored and enforced by the fund management module 210 and presented to participants through the participant interface module 220.

At block 308, the system transmits a dynamic invitation link to prospective participants. The dynamic link, generated by the communication module 202, may include real-time indicators of the group name, current pledge level, available participation slots, requested contribution amount, and contribution instructions.

At block 310, the organizer may be transferred to another member of the fund. The fund management module 210 may update the user record associated with the organizer role and allow the new organizer to manage the fund without interrupting the state of the aggregated payment instrument.

At block 312, the organizer and/or participants enter or select the amount they wish to contribute along with an associated payment method. The participant interface module 220 may receive and validate these entries, which are then stored via the user module 212 and the database engine 204.

At block 314, the notification module 226 transmits automated status updates to the organizer and participants. These updates may inform users of pledge changes, remaining balance needed to meet the goal, new participants joining, or readiness for activation.

FIG. 3B illustrates an example method for activating a purchasing fund, transacting with an aggregated payment instrument, and handling post-purchase operations, as may be performed by the computing system 100. The operations shown may be implemented across several modules of application program 200, including the fund management module 210, payment orchestration module 222, transaction settlement module 224, manual adjustment module 228, and replenishment module 230.

At block 316, the organizer initiates activation of the group fund, signaling that the system should proceed with processing purchases using the pledged contributions currently available. This activation event may be processed by the fund management module 210, which transitions the purchasing fund from a prospective state to a live state.

At block 318, the system permits additional participants to join even after the fund is activated. When new pledges are submitted, the fund management module 210 and payment orchestration module 222 may recalculate the aggregated limit and update the available spend balance of the associated payment instrument accordingly.

At block 320, the system performs authorization events. The organizer's payment method may be pre-authorized or charged for the total group amount, and similarly, each participant's payment method may be pre-authorized or authorized up to their pledged amount. The payment orchestration module 222 executes these authorizations using tokenized payment credentials through third-party computing device 195.

At block 322, the generated or designated payment instrument is used to make a purchase at a merchant. The merchant charges the instrument via a standard point-of-sale or online transaction interface. The transaction is routed through standard payment networks and approved based on the aggregate authorized amount.

At block 324, additional funds may be added to the purchasing fund post-activation without requiring formation of a new group. This may occur through the participant interface module 220 and be coordinated by the fund management module 210 to adjust the aggregated spend limit.

At block 326, the transaction settlement module 224 processes the final purchase by calculating each participant's charge according to their pledged contribution. Organizer and participant devices may receive confirmations, including final charge summaries and itemized shares.

At block 328, the organizer may choose whether to reload the payment instrument for future use, cancel the payment instrument, add funds, or close the purchasing fund. If the payment instrument is configured to be persistent and reusable, no additional action is required. This decision is managed through the fund management module 210 in coordination with the user module 212.

At block 330, the manual adjustment module 228 processes any returned funds. If the merchant issues a refund to the payment instrument, the system allocates the refunded amount among participants based on their original proportional contributions or according to organizer-defined rules. These refunds may be credited directly back to the payment methods associated with each participant.

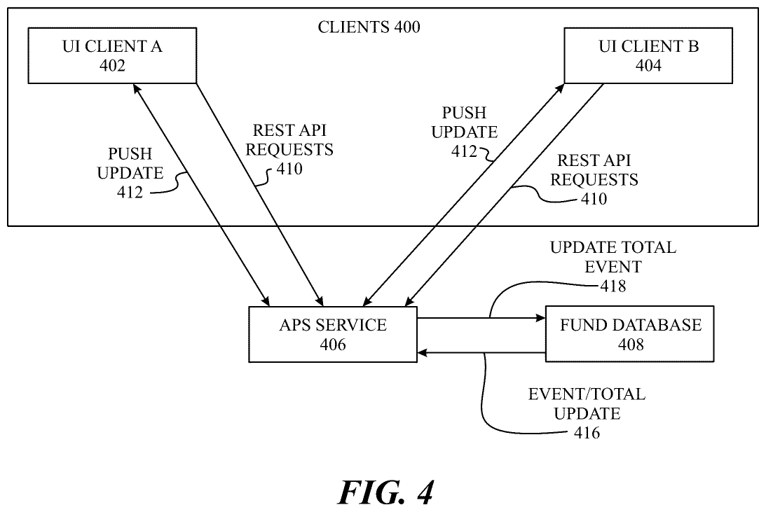

FIG. 4 illustrates an example system architecture for handling real-time fund updates and client synchronization using the Aggregated Payment System (APS) service. The illustrated architecture supports the transmission of API requests, event-driven database updates, and real-time push notifications to user interface (UI) clients participating in a group purchasing fund.

The system includes a set of clients 400, which may include multiple user interface clients, such as UI client A 402 and UI client B 404. These clients may correspond to participant devices or organizer computing devices (e.g., user computing device 145 or administrator computing device 185), each running software that interfaces with the APS service 406.

Each UI client may transmit REST API requests 410 to the APS service 406 to perform fund-related actions such as submitting pledges, modifying contributions, or requesting current fund status. The APS service 406, which may implement logic from the fund management module 210, payment orchestration module 222, and participant interface module 220, processes these requests and updates the underlying fund database 408 accordingly.

When a client's action results in a change to the fund's total pledged amount or state, the APS service 406 generates an update total event 418. This event is written to the fund database 408 and may trigger an event/total update 416 stored within the database. These updates ensure that the fund's real-time balance and configuration are accurately recorded for subsequent operations, including transaction authorization and settlement.

To maintain consistency across user interfaces, the APS service 406 also dispatches push updates 412 to the UI clients. These push updates notify participants of changes to the fund status, such as new pledges, contribution modifications, or goal attainment, without requiring manual refresh or polling. The updates may be delivered using web sockets, long polling, or push messaging protocols, enabling synchronous awareness of fund status among all connected clients.

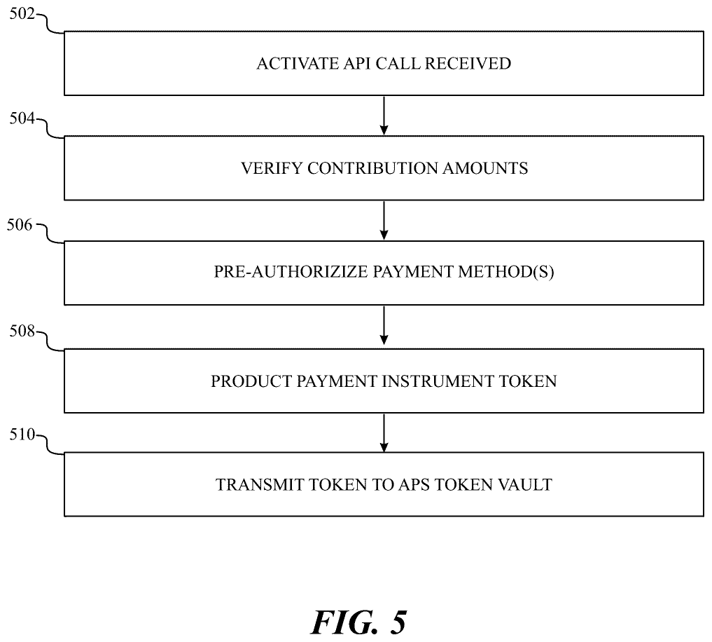

FIG. 5 illustrates an example process for activating a purchasing fund and generating a tokenized payment instrument within the computing system 100. The steps shown may be performed by the payment orchestration module 222 in coordination with the fund management module 210 and user module 212.

At block 502, the system receives an activate API call, which may be initiated by the organizer through a user interface or triggered by a scheduled event once the funding threshold has been met. This API call signals that the purchasing fund should transition from a pending state to an active state, enabling transactions using the pledged contributions.

At block 504, the system proceeds to verify contribution amounts. The payment orchestration module 222 may access the fund database 408 to retrieve each participant's pledged amount and ensure that the combined total meets the requirements for activation. The system may also confirm that each participant's pledge complies with organizer-defined rules.

At block 506, the system executes pre-authorization of payment methods. Each participant's stored payment method may be tokenized and submitted for a pre-authorization transaction through a third-party payment gateway. These authorizations ensure that sufficient funds are available before enabling the fund for spending. The system may also perform finalization for pledges configured as immediate charges rather than holds.

At block 508, the system generates a payment instrument token, representing a virtual card or equivalent payment credential. The token may be created through interaction with a card issuing processor and encapsulates attributes such as expiration date, card number, CVV-equivalent, and spend limit based on the aggregated pledges.

At block 510, the system transmits the token to an APS token vault. The token vault may be a secure, PCI DSS-compliant component of the APS service that stores the payment instrument for subsequent use in online or in-store transactions. The generated token is now available for authorization requests made on behalf of the group fund using standard payment networks.

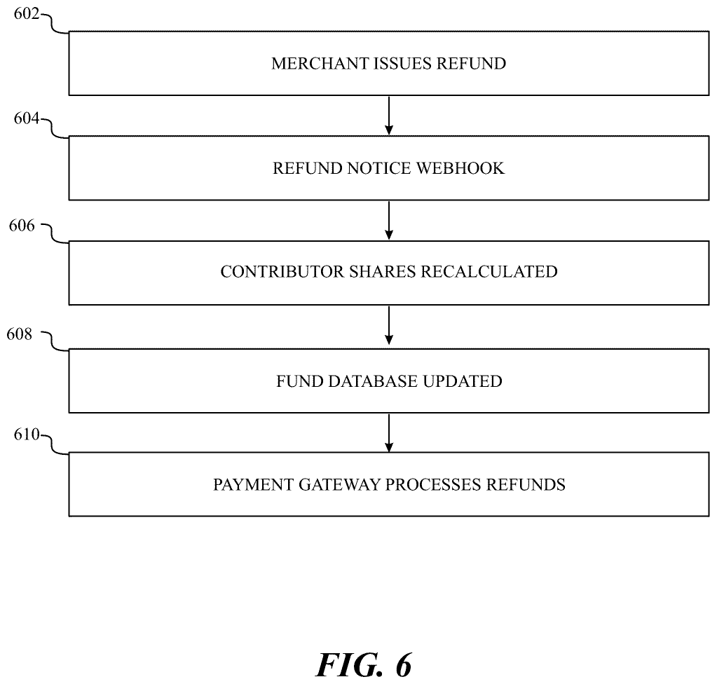

FIG. 6 illustrates an example refund handling workflow for allocating and processing refunds issued to an aggregated payment instrument. This process may be executed by the manual adjustment module 228 in coordination with the payment orchestration module 222, fund database 408, and one or more external payment gateways.

At block 602, a merchant issues a refund to the aggregated payment instrument. This may occur when a transaction is canceled, partially returned, or otherwise reversed by the merchant. The refund may be processed through the same card network originally used to settle the purchase.

At block 604, the system receives a refund notice webhook. This webhook is a programmatically triggered notification sent from the payment processor or merchant gateway to the APS service 406. The webhook typically includes transaction identifiers, refund amounts, and timing details necessary to initiate internal refund reconciliation.

At block 606, the system recalculates contributor shares. The manual adjustment module 228 determines how the total refunded amount should be distributed among participants. The default method may be proportional to each participant's original contribution toward the refunded transaction. Alternatively, custom allocation rules defined by the organizer may govern the distribution.

At block 608, the fund database is updated. The manual adjustment module 228 and database engine 204 store the revised refund allocation records, associating each participant with their corresponding share. The updated data ensures traceability of refund transactions and enables participant interfaces to reflect accurate refund histories.

At block 610, the payment gateway processes refunds back to the contributors. Each refund share may be routed to the original payment method used by the participant, such as a linked credit card or tokenized digital wallet credential. The payment orchestration module 222 may manage the initiation of these transactions, interfacing with external systems such as third-party computing devices 195.

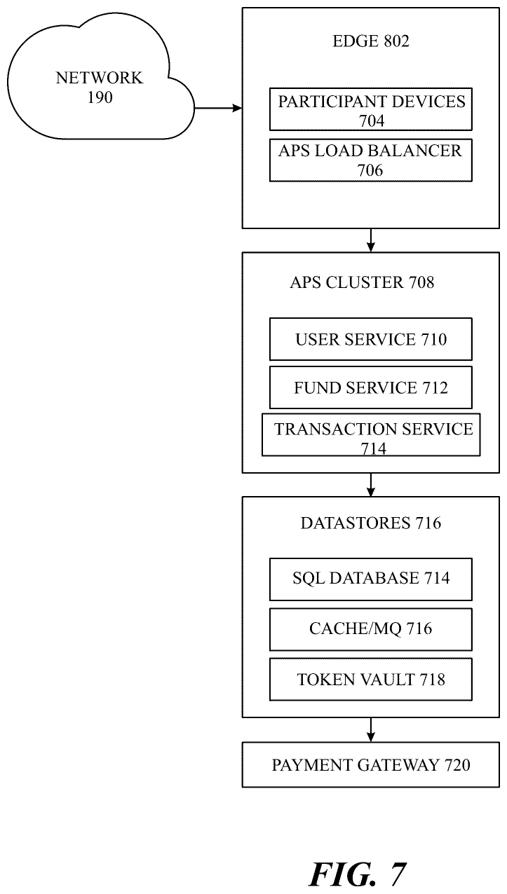

FIG. 7 illustrates an example system deployment architecture for the Aggregated Payment System (APS), showing how participant devices interact with distributed services and data layers to manage purchasing funds, transaction execution, and payment instrument provisioning. The architecture interfaces with a network 190, which may include the Internet or a private communication network used to connect participant devices and backend APS services. At the system edge, an edge layer 802 includes one or more participant devices 704, which may correspond to user computing devices 145 or administrator computing devices 185. These devices submit requests and receive updates related to fund creation, contribution pledges, activation, and refund status.

Incoming traffic may be routed through an APS load balancer 706, which distributes API requests across the internal service tier of the system to optimize availability and performance.

Within the APS cluster 708, multiple microservices may execute application logic. A user service 710 may manage user authentication, profile data, and participant preferences, consistent with the functions of the user module 212. A fund service 712 may implement operations for creating, configuring, and activating purchasing funds, aligning with the functionality of the fund management module 210 and payment orchestration module 222. A transaction service 714 may handle authorization, settlement, refund, and allocation processes for payment instruments, corresponding to the transaction settlement module 224 and manual adjustment module 228.

The APS cluster 708 interacts with backend datastores 716, which include an SQL database 714 for persistent structured data storage, such as fund configurations, user accounts, pledges, and transaction records. A cache/message queue (MQ) 716 may be used to facilitate asynchronous communication and optimize the performance of high-volume updates, such as real-time status changes or push notifications. A token vault 718 may securely store payment instrument credentials, including virtual card tokens, in compliance with industry security standards (e.g., PCI DSS). This component supports token lifecycle management, secure access, and vault-to-gateway transmission.

The architecture further includes a connection to a payment gateway 720, which may represent an external payment processing service or financial institution system. The APS cluster 708 communicates with the payment gateway 720 to place holds, finalize charges, issue refunds, and generate payment instrument tokens that are accepted by standard card networks.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for facilitating consolidated payments using aggregated pledges from multiple contributors, the system comprising:
a memory storing instructions; and
a processor configured to execute the instructions to:
receive, from an organizer device, a request to establish a purchasing fund associated with a payment goal;
transmit dynamic invitations to a plurality of participant devices, each configured to receive user pledges of a contribution amount via a payment method;
prior to activation of the purchasing fund, allow participants to modify or withdraw pledges according to organizer-defined permissions;
upon activation, place a pre-authorization hold or finalize a charge on each pledged amount, thereby enabling an aggregated payment instrument recognized by a payment network;
authorize purchases through the aggregated payment instrument within a total amount not exceeding a sum of pledged contributions; and
settle transactions by charging each participant an amount corresponding to their proportion of total pledges, up to their pledged limit.

2. The system of claim 1, wherein the processor is further configured to support an addition of new participants after activation, and to dynamically update the payment instrument's available balance based on newly pledged contributions.

3. The system of claim 1, wherein each transaction initiated using the aggregated payment instrument generates a real-time notification delivered to each participant indicating transaction amount, merchant identity, and participant-specific charges.

4. The system of claim 1, wherein the payment instrument is a persistent virtual card associated with an organizer's account and is regenerable upon request without disrupting fund continuity.

5. The system of claim 1, wherein at least one refund processed through the system is distributed to participants according to a custom allocation ratio specified by the organizer.

6. The system of claim 1, wherein the payment instrument is a physical card issued to the organizer, activated through a secure protocol upon delivery.

7. The system of claim 1, wherein the processor is further configured to close the purchasing fund based on expiration criteria, and to automatically refund unused amounts to each participant without manual input.

8. The system of claim 1, wherein each participant can view real-time dashboards showing their pledge status, transaction participation, and refund history.

9. A computer-implemented method for dynamic funding and usage of a universal payment instrument, the method comprising:
receiving, from an organizer, a request to initiate a purchasing fund with at least one funding model selected from open or contribution-based;
presenting a dynamic invitation link to prospective participants, the link displaying real-time funding progress;
receiving pledges from a plurality of participants, each pledge associated with a respective payment method;
upon reaching a funding threshold or receiving an activation input, placing pre-authorization holds or charges on pledged amounts;
generating or activating a payment instrument linked to the purchasing fund, the instrument being accepted by standard payment networks;
processing transactions made using the payment instrument, including calculating and charging each participant's share of the purchase; and
automatically redistributing any refunds proportionally based on participant contributions or a predefined allocation rule.

10. The method of claim 9, wherein the act of presenting the dynamic invitation link comprises embedding real-time indicators of current pledges, total goal, and remaining slots available for contribution.

11. The method of claim 9, further comprising transferring ownership of the purchasing fund from the original organizer to a designated participant without regenerating the payment instrument.

12. The method of claim 9, further comprising determining a utilization threshold for the payment instrument, and upon reaching the threshold, prompting one or more participants to provide additional contributions to avoid transaction declines.

13. The method of claim 9, further comprising monitoring for transaction decline events due to insufficient funds, and upon detecting such an event, issuing a real-time prompt to at least one participant to contribute additional funds to enable continuation of the purchase.

14. The method of claim 9, wherein post-activation changes to participant pledges are supported and the system updates allocation logic accordingly without deactivating the payment instrument, wherein the updates comprise dynamically reducing each existing participant's share of future transaction amounts in response to one or more new participants joining the purchasing fund and contributing to the aggregate total.

15. The method of claim 9, wherein an aggregated payment instrument is valid at any merchant that accepts standard credit or debit card transactions without requiring merchant-specific integration.

16. The method of claim 9, further comprising logging and classifying each transaction using artificial intelligence modules to facilitate reporting and behavioral analysis.

17. A non-transitory computer-readable medium storing instructions that, when executed by at least one processor, cause the processor to:
create a purchasing fund upon request from an organizer;
accept pledges from one or more contributors, each pledge representing a financial commitment linked to a payment method;
permit modifications to pledged amounts prior to activation and optionally post-activation if allowed by organizer settings;
upon activation, generate or designate a virtual or physical payment instrument backed by total pledged funds;
enable transaction authorizations using the payment instrument, constrained by a cumulative available balance;
adjust participant charges dynamically based on transaction amount changes during settlement; and
release unused pre-authorized funds or issue refunds to each contributor automatically upon closure of the fund.

18. The computer-readable medium of claim 17, wherein the instructions further cause the processor to generate participant-specific transaction summaries and refund receipts via electronic delivery methods including email or SMS.

19. The computer-readable medium of claim 17, wherein the payment instrument is compatible with mobile wallets, enabling contactless transactions via near-field communication (NFC).

20. The computer-readable medium of claim 17, wherein the processor is further configured to monitor fraud indicators or anomalies in participant contributions or transactions, and to flag suspicious activity for review.
